(19) United States
(12) Patent Application Publication
(10) Pub. No.: US 2025/0155872 A1
(43) Pub. Date: May 15, 2025

(54) MULTI-OBJECTIVE OPTIMIZATION METHOD AND DEVICE FOR CATALYTIC CRACKING PROCESS

(71) Applicant: EAST CHINA UNIVERSITY OF SCIENCE AND TECHNOLOGY, Shanghai (CN)

(72) Inventors: Weimin ZHONG, Shanghai (CN); Jian LONG, Shanghai (CN); Wenli DU, Shanghai (CN); Feng QIAN, Shanghai (CN); Minglei YANG, Shanghai (CN)

(21) Appl. No.: 18/833,310

(22) PCT Filed: Jan. 13, 2023
(86) PCT No.: PCT/CN2023/071999

§ 371 Date: Jul. 25, 2024

(30) Foreign Application Priority Data
Jan. 25, 2022 (CN) 202210089249.9

(51) Int. Cl. G05B 19/4155

(52) U.S. Cl. CPC G05B 19/4155; G05B 2219/32287

(57) ABSTRACT

The present invention provides a multi-objective optimization method and a device for catalytic cracking process, and a computer-readable storage medium. The multi-objective optimization method comprises following steps: determining a plurality of optimization objectives, a plurality of process decision variables corresponding to the plurality of optimization objectives, and a constraint range of each of the process decision variables; determining an objective function according to the plurality of optimization objectives and the plurality of process decision variables; adjusting a value of each of the process decision variables within the constraint range by SPEA2 algorithm, which improves filial generation evolution process through a path-based reproduction operator, thereby determining an operation data of the objective function on each of the process decision variables; determining an optimization objective value of each of the optimization objectives according to the operation data of each of the process decision variables; and determining the operation data as guide values of the plurality of process decision variables, corresponding to the plurality of optimization objectives, according to an optimal optimization objective value solution set.

### TECHNICAL FIELD

The present invention belongs to the technical field of petrochemical industry, in particular to a multi-objective optimization method for catalytic cracking process, a multi-objective optimization device for catalytic cracking process, and a computer-readable storage medium.

### BACKGROUND

The oil refining industry is a pillar industry in our country, wherein the catalytic cracking process is one of the important means of heavy oil lightening in the oil refining industry. Catalytic cracking products such as gasoline and diesel oil obtained through the Fluid Catalytic Cracking (FCC) process are important sources of fuel for transportation, while other products produced through the Fluid Catalytic Cracking process are also the main raw materials provided for the chemical industry. For oil refining enterprises, how to give full play to the capacity of oil refining devices, maximize economic benefits and reduce environmental pollution is a top priority related to the national economy and the people's livelihood, and also a strong guarantee for the country to achieve industrial transformation and upgrading.

In the practical application of catalytic cracking process, multiple conflicting optimization objectives, such as economic benefits and environmental protection, should be comprehensively considered, that is, multi-objective optimization. However, the existing catalytic cracking optimization technologies in the petrochemical field mainly focus on the optimization operation of a single objective, which cannot meet the actual needs of multi-objective optimization. Even if there are multi-objective optimization related technologies in other technical fields such as information science and technology, there is a widespread phenomenon of ignoring the useful information generated in the process of individual evolution, which requires a large number of iterations, and there are defects such as long optimization time, poor quality of optimization results, and unstable optimization results.

In order to overcome the above defects of the existing technology, the field urgently needs a multi-objective optimization technology for the catalytic cracking process, which can meet the multi-objective optimization requirements of the catalytic cracking process on the one hand, improve the multi-objective optimization efficiency of the catalytic cracking process on the other hand, and improve the quality and stability of the optimization results.

### SUMMARY

A brief overview of one or more aspects is provided below to provide a basic understanding of these aspects. The summary is not an exhaustive overview of all aspects envisaged, and is neither intended to identify the key or decisive elements of all aspects nor to attempt to define the scope of any or all aspects. The sole purpose of the summary is to present some concepts of one or more aspects in a simplified is form as a prelude to the more detailed description that is presented later.

In order to overcome the above defects of the existing technology, the present invention provides a multi-objective optimization method for the catalytic cracking process, a multi-objective optimization device for the catalytic cracking process, and a computer-readable storage medium, which can adjust a value of each of the process decision variables within the constraint range by SPEA2 algorithm, to determine the operation data as guide values of the plurality of process decision variables, so as to meet the multi-objective optimization requirements of the catalytic cracking process, improve the multi-objective optimization efficiency of the catalytic cracking process, and improve the quality and stability of the optimization results.

Specifically, the multi-objective optimization method for catalytic cracking process provided in the first aspect of the present invention comprises following steps: determining a plurality of optimization objectives, a plurality of process decision variables corresponding to the plurality of optimization objectives, and a constraint range of each of the process decision variables; determining an objective function according to the plurality of optimization objectives and the plurality of process decision variables; adjusting a value of each of the process decision variables within the constraint range by SPEA2 algorithm, which improves filial generation evolution process through a path-based reproduction operator, thereby determining an operation data of the objective function on each of the process decision variables; determining an optimization objective value of each of the optimization objectives according to the operation data of each of the process decision variables; and determining the operation data as guide values of the plurality of process decision variables, corresponding to the plurality of optimization objectives, according to an optimal optimization objective value solution set.

Further, in some embodiments of the present invention, the steps of adjusting a value of each of the process decision variables within the constraint range by SPEA2 algorithm, which improves filial generation evolution process through a path-based reproduction operator, thereby determining an operation data of the objective function on each of the process decision variables comprise: S1: initializing an iteration count variable t, a population Pₜ and a reserve set P̅ₜ̅, wherein initialized population P₀ is composed of a set of the plurality of process decision variables when t=0, and initialized reserve set P̅₀̅ is an empty set; S2: calculating a fitness degree F(i) of each individual i in the population Pₜ, wherein each of the individuals i corresponds to one of the process decision variables; S3: copying the population Pₜ and all non-dominated solution sets in the reserve set P̅ₜ̅ to a reserve set P̅ₜ̅₊̅₁̅, and performing an environmental selection on the reserve set P̅ₜ̅₊̅₁̅; S4: if iteration count t does not reach a preset upper limit of iteration count T, performing a tournament selection on the reserve set P̅ₜ̅₊̅₁̅ that have undergone the environmental selection, and putting a data set that have undergone the tournament selection into a mating pool; S5: calculating the data set in the mating pool through the path-based reproduction operator and storing calculation results in the reserve set P̅ₜ̅₊̅1̅, increasing the iteration count, and returning to the step S2; and S6: if the iteration count t reaches the upper limit of iteration count T, outputting a process decision variable set A represented by non-dominated solutions in the reserve set P̅ₜ̅₊̅₁̅.

Further, in some embodiments of the present invention, the steps of calculating a fitness degree F(i) of each individual i in the population Pₜ comprise: determining an original fitness value R(i) of the individual i according to an individual quantity S(i) dominated by the individual i, wherein the original fitness value R(i) represents a sum of quantity of all individuals dominated by the individual i and each individual j that dominates the individual i; calculating a distance from each of the individuals i to each individual in the population Pₜ and the reserve set P̅ₜ̅, and sorting the distances in an ascending order; selecting a kth individual as σᵢ^{k}, and calculating a corresponding distance value D(i), wherein k=\sqrt{N+N̅}, N is a size of the population Pₜ, and N̅ is a size of the reserve set P̅ₜ̅; and determining the fitness degree F(i) of the individual, according to the original fitness value R(i) and the distance value D(i).

Further, in some embodiments of the present invention, the steps of performing an environmental selection on the reserve set P̅ₜ̅₊̅₁̅ comprise: comparing an individual quantity in the reserve set P̅ₜ̅₊̅₁̅ with the size N̅ of the reserve set; if |P̅ₜ̅₊̅₁̅|<|N̅|, selecting first N̅−|P̅ₜ̅₊̅₁̅| individuals from all individuals i in the population Pₜ and the reserve set P̅ₜ̅ according to order of the fitness degree F(i) to form a dominated solution set, and adding it to the reserve set P̅ₜ̅₊̅₁̅; and if |p̅ₜ̅₊̅₁̅|>|N̅|, performing a pruning operation, thereby eliminating the individual i with a minimum distance from its adjacent individual in each iteration.

Further, in some embodiments of the present invention, the step of eliminating the individual i with a minimum distance from its adjacent individual in each iteration comprises: eliminating one individual i with a minimum distance from its adjacent individual in each of the iterations.

Further, in some embodiments of the present invention, the steps of calculating the data set in the mating pool through the path-based reproduction operator comprise: determining a center point Center_{g} of an offspring population individual in the reserve set P̅ₜ̅₊̅₁̅, and determining a center point Center_{g-1} of a parental population individual in the population Pₜ and the reserve set P̅ₜ̅; defining a direction of an evolution path ep according to a difference between the individual center points of two generations of populations; determining a forward moving step α of the evolution path ep according to a target survival rate p_{succ}^{target} and an actual productive rate p_{succ} of offspring individuals; and generating corresponding offspring individuals within a rectangular range pointed by a vector α*ep, by taking each parental individual as a starting point.

Further, in some embodiments of the present invention, the steps of recombining and mutating each of the individuals i in the mating pool through the path-based reproduction operator further comprise: after generating the offspring individuals, performing a gene sharing operation between at least one excellent parental individual and each of the offspring individuals.

Further, in some embodiments of the present invention, before performing the gene sharing operation, the multi-objective optimization method further comprises following steps: obtaining a number of Pareto front layers or the fitness degree F(i) of each of the parental individuals; and screening at least one excellent parental individual according to the number of the Pareto front layers or the fitness degree F(i).

Further, in some embodiments of the present invention, before determining the operation data as guide values of the plurality of process decision variables, corresponding to the plurality of optimization objectives, according to an optimal optimization objective value solution set, the multi-objective optimization method also comprises a following step: evaluating each of the optimization objective values according to a Pareto optimal solution set and an IGD index, thereby determining the optimal optimization objective value solution set.

Further, in some embodiments of the present invention, the plurality of optimization objectives at least comprise minimizing carbon dioxide emission.

Further, in some embodiments of the present invention, the plurality of optimization objectives also comprise at least one of maximizing economic benefit, minimizing sulfur dioxide emission, minimizing total exhaust gas emission, minimizing total waste liquid emission, maximizing main product output, maximizing main product yield, and minimizing input cost.

Further, in some embodiments of the present invention, the plurality of process decision variables at least comprise at least one of material flow, material state, material property, main fractionate tower state, main fractionate tower operation, absorption tower state, absorption tower operation, re-absorption tower state, re-absorption tower operation, desorption tower state, desorption tower operation, stabilization tower state, and stabilization tower operation.

Further, in some embodiments of the present invention, the plurality of optimization objectives comprise maximizing economic benefit, minimizing carbon dioxide emission and minimizing sulfur dioxide emission, and the objective function is as follows:

$$min imizeF ( x ) = ( 1 / {f}_{1} , {f}_{2} , {f}_{3} ) ,$$

$${f}_{1} = max M = {\sum }_{i} {P}_{i} \times {Y}_{i} - {\sum }_{j} {p}_{j} \times {y}_{j} - {P}_{f} \times F - {p}_{c} \times {f}_{c} ,$$

$${f}_{2} = min {C}_{CO 2} ,$$

$${f}_{3} = min {C}_{SO 2} ,$$

wherein M indicates economic benefit of the catalytic cracking process; Pᵢ indicates price of product i; Yᵢ indicates flow of product i; i indicates products, comprising at least one of sour gas, dry gas, ethylene, liquefied gas, propylene, gasoline, diesel oil, circulating oil, slurry and coke; pⱼ indicates price of raw material j; yⱼ indicates flow of raw material j; j indicates raw materials, including residual oil in tank farm, wax oil in tank farm and refined wax oil; P_{f} indicates fixed cost per unit processing quantity, F indicates processing load; P_{c} indicates price of fresh catalyst and f_{c} indicates supplement amount of fresh catalyst; C_{CO2} indicates carbon dioxide emission; C_{SO2} represents sulfur dioxide emission.

In addition, the multi-objective optimization device provided in the second aspect of the present invention comprising a memory and a processor. The processor is connected to the memory and configured to implement the multi-objective optimization method for catalytic cracking process according to the first aspect of the present invention.

In addition, the computer-readable storage medium provided in the third aspect of the present invention, in which computer instructions are stored. When the computer instructions are executed by a processor, the multi-objective optimization method for catalytic cracking process according to the first aspect of the present invention is implemented.

### BRIEF DESCRIPTION OF THE DRAWINGS

The above features and advantages of the present invention will be better understood after reading the detailed description of the embodiments of the present disclosure in conjunction with the following figures. In the figures, components are not necessarily drawn to scale, and components having similar related features may have the same or similar reference numerals.

FIG. 1 shows a flow schematic diagram of the multi-objective optimization method for catalytic cracking process provided according to some embodiments of the present invention.

FIG. 2 shows a schematic diagram of a catalytic cracking device provided according to some embodiments of the present invention.

FIG. 3 shows a flow schematic diagram of adjusting process decision variables provided according to some embodiments of the present invention.

FIG. 4 shows a flow schematic diagram for calculating a data set in a mating pool provided according to some embodiments of the present invention.

FIG. 5A shows a schematic diagram of an evolution path at the early stage of the evolution provided according to some embodiments of the invention.

FIG. 5B shows a schematic diagram of an evolution path at the later stage of the evolution provided according to some embodiments of the invention.

FIG. 6 shows a schematic diagram of generating offspring individuals provided according to some embodiments of the present invention.

FIG. 7 shows a schematic diagram of IGD indicators provided according to some embodiments of the present invention.

FIG. 8 shows a schematic diagram of a Pareto optimal solution set provided according to some embodiments of the present invention.

### DETAILED DESCRIPTION OF EMBODIMENTS

The implementations of the present invention are described below by specific embodiments. Those skilled in the art can easily understand other advantages and effects of the present invention from the contents disclosed in the description. Although the description of the present invention is introduced together with preferred embodiments, it does not mean that the features of the present invention are limited to the embodiments. On the contrary, the purpose of introducing the present invention in combination with the embodiments is to cover other options or modifications that may be extended based on the claims of the present invention. In order to provide a deep understanding of the present invention, the following description will contain many specific details. The present invention can also be implemented without using these details. In addition, in order to avoid confusion or ambiguity of the key points of the present invention, some specific details is omitted in the description.

As mentioned above, the existing catalytic cracking optimization technologies in the petrochemical field mainly focus on the optimization operation of a single objective, which cannot meet the actual needs of multi-objective optimization. Even if there are multi-objective optimization related technologies in other technical fields such as information science and technology, there is a widespread phenomenon of ignoring the useful information generated in the process of individual evolution, which requires a large number of iterations, and there are defects such as long optimization time, poor quality of optimization results, and unstable optimization results.

In order to overcome the above defects of the existing technology, the present invention provides a multi-objective optimization method for the catalytic cracking process, a multi-objective optimization device for the catalytic cracking process, and a computer-readable storage medium, which can adjusting a value of each of the process decision variables within the constraint range by SPEA2 algorithm, to determine the operation data as guide values of the plurality of process decision variables, so as to meet the multi-objective optimization requirements of the catalytic cracking process, improve the multi-objective optimization efficiency of the catalytic cracking process, and improve the quality and stability of the optimization results.

In some non-limiting embodiments, the multi-objective optimization method of the above catalytic cracking process provided in the first aspect of the present invention can be implemented by the multi-objective optimization device of the above catalytic cracking process provided in the second aspect of the present invention. Specifically, the multi-objective optimization device is configured with a memory and a processor. The memory includes, but is not limited to, the computer-readable storage medium provided in the third aspect of the present invention, in which computer instructions are stored. The processor is connected to the memory and configured to implement the multi-objective optimization method of the catalytic cracking process provided in the first aspect of the present invention.

The working principle of the above multi-objective optimization device will be described below in conjunction with some embodiments of some image processing methods. Those skilled in the art can understand that the embodiments of these multi-objective optimization methods only provide some non-limiting implementations of the present invention, which is intended to clearly display the main idea of the present invention, and provide some specific proposals that are convenient for the public to implement, rather than limiting all working modes or all functions of the multi-objective optimization device. Similarly, the multi-objective optimization device is only a non-limiting embodiment provided by the present invention, and does not limit the implementation subject to each step in these multi-objective optimization methods.

Please referring to FIG. 1 first, FIG. 1 shows a flow schematic diagram of the multi-objective optimization method for catalytic cracking process provided according to some embodiments of the present invention.

As shown in FIG. 1, in the process of multi-objective optimization, the multi-objective optimization unit can first determine a mechanism model of the catalytic cracking process, and determine a plurality of optimization objectives, a plurality of process decision variables corresponding to the plurality of optimization objectives, and a constraint range of each of the process decision variables according to the mechanism model.

In some embodiments, the mechanism model can be pre built offline by those skilled in the art, for users to select and use in the process of multi-objective optimization directly, or can be directly established by users based on the process mechanism of the catalytic cracking device in the process of multi-objective optimization.

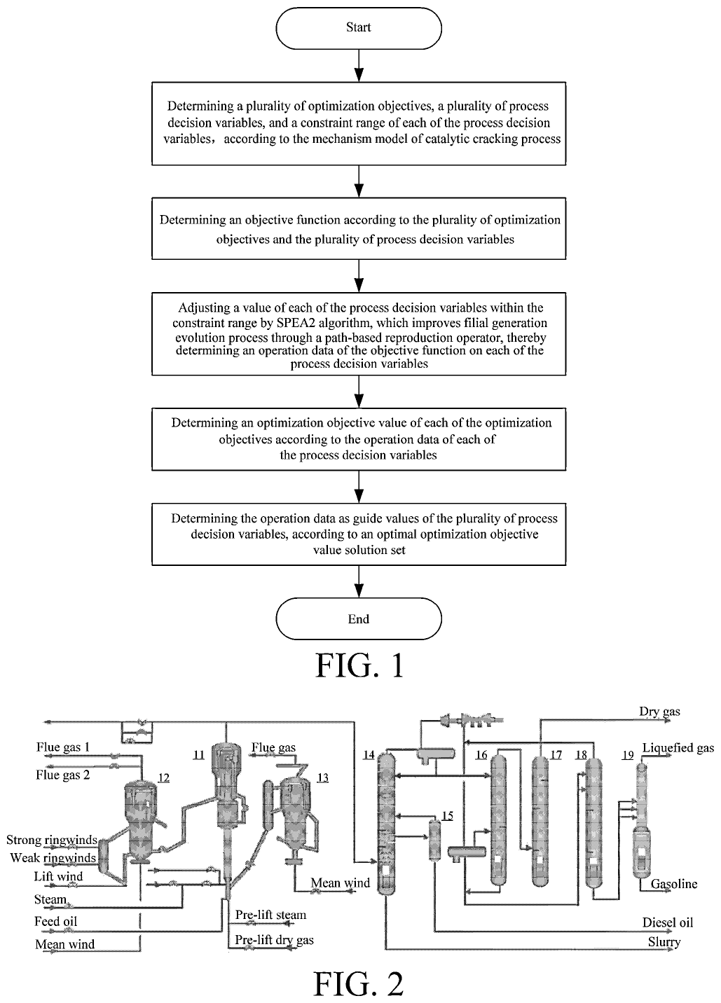

Taking the catalytic cracking device shown in FIG. 2 as an example, it is mainly composed of five parts: reaction-reproduction system, fractionation system, absorption stabilization system, product refining system and energy recovery. It can transform heavy fractions such as atmospheric residue, coking distillate oil, de-asphalting oil, vacuum wax oil and other heavy fractions into high-quality dry gas, liquefied petroleum gas, stabilized gasoline and light diesel oil and other light products under the action of heating and catalyst.

Specifically, the above reaction reproduction system is generally composed of riser reactor 11 and catalyst regenerators 12 and 13. Reactor 11 is mainly used to react the feed oil passing through to generate objective products under certain reaction temperature, pressure and catalyst. These complex products enter the fractionation system in the form of gas through the oil and gas pipeline at high temperature. During the reaction, the catalyst surface temporarily loses its activity due to the attachment of coke generated. These deactivated catalysts will enter regenerators 12 and 13 to burn off the coke with oxygen in the air, so that the catalyst will be reactivated. The heat released from coke will be brought into reactor 11 by regenerated catalyst for reaction, and the excess heat will be recycled by equipment.

The fractionation system mainly includes fractionate tower 14, stripping tower 15, feed oil buffer recycle tank and heat exchange system. The system is mainly used to separate high-temperature oil and gas from reactor 11 into rich gas, crude gasoline, sulfur-containing sewage, light gasoline, back refining oil and slurry according to different boiling points of each fraction.

The absorption and stabilization system mainly includes absorption tower 16, re-absorption tower 17, desorption tower 18 and stabilization tower 18, as well as rich gas compressor and corresponding heat exchange system. The main task of the system is to separate the crude gasoline and rich gas separated from the oil gas separator on the top of the fractionate tower 14, and separate them into dry gas, liquefied gas, stabilized gasoline and other products by using the different solubility of each component in the liquid. Control the indicators of each product to meet the product requirements.

The product refining system is set behind the absorption stabilization system, which is mainly used for refining dry gas, liquefied gas and stabilized gasoline, such as desulfurization and desulfurization alcohol, to meet the relevant requirements of the environmental protection law for products.

The energy recovered by the energy recovery system is mainly used to maintain the heat balance of the reaction-reproduction system and fractionation system. The system is usually composed of flue gas energy recovery unit, residual heat boiler, external heat collector, slurry steam generator at the bottom of fractionate tower and water supply system. The recovered energy mainly includes the residual heat in the regenerator, the pressure energy of the regenerated flue gas, the heat energy and the residual heat of the fractionation system.

Those skilled in the art can conduct operations such as feed oil characterization, composition division, reaction network division, and reaction kinetics model establishment according to the structure and reaction mechanism of the catalytic cracking device. The whole process mechanism model of catalytic cracking is formed by using the hydrocarbon reaction kinetics reaction system coupled with carbon number distribution, sulfur and nitrogen distribution. The specific proposal is the existing technology in the field, and will not be described here.

Further, in some embodiments, after establishing the mechanism model of the catalytic cracking process, those skilled in the art can also correct the model parameters of the catalytic cracking mechanism model. Specifically, those skilled in the art can use intelligent optimization algorithms to determine the optimization values of model parameters that meet the accuracy requirements within the constraint range of the input parameters of the catalytic cracking mechanism model, and update the model parameters of the catalytic cracking mechanism model with the optimization values of the obtained model parameters to improve the accuracy of the model, and make the output values of the catalytic cracking mechanism model consistent with the production data, so as to make the output values of the catalytic cracking mechanism model more accurate.

After establishing the mechanism model of the catalytic cracking process, the multi-objective optimization device can obtain a plurality of optimization objectives provided by user, and determine a plurality of process decision variables corresponding to the plurality of optimization objectives and the constraint range of each of the process decision variables according to the mechanism model of the catalytic cracking process. In some embodiments, the plurality of optimization objectives can include at least one of maximizing economic benefit, minimizing carbon dioxide emission, minimizing sulfur dioxide emission, minimizing total exhaust gas emission, minimizing total waste liquid emission, maximizing main product output, maximizing main product yield, and minimizing input cost. In particular, under the environmental protection background of advocating “carbon neutrality”, the plurality of optimization goals can at least include the optimization goal of minimizing carbon dioxide emission.

Taking the three optimization objectives of maximizing economic benefit, minimizing carbon dioxide emission and minimizing sulfur dioxide emission as an example, the objective function is as follows:

$$min imizeF ( x ) = ( 1 / {f}_{1} , {f}_{2} , {f}_{3} ) ,$$

$${f}_{1} = max M = {\sum }_{i} {P}_{i} \times {Y}_{i} - {\sum }_{j} {p}_{j} \times {y}_{j} - {P}_{f} \times F - {p}_{c} \times {f}_{c} ,$$

$${f}_{2} = min {C}_{CO 2} ,$$

$${f}_{3} = min {C}_{SO 2} ,$$

wherein M indicates economic benefit of the catalytic cracking process; Pᵢ indicates price of product i; Yᵢ indicates flow of product i; i indicates products, comprising at least one of sour gas, dry gas, ethylene, liquefied gas, propylene, gasoline, diesel oil, circulating oil, slurry and coke; pⱼ indicates price of raw material j; yⱼ indicates flow of raw material j; j indicates raw materials, including residual oil in tank farm, wax oil in tank farm and refined wax oil; P_{f} indicates fixed cost per unit processing quantity, F indicates processing load; p_{c} indicates price of fresh catalyst and f_{c} indicates supplement amount of fresh catalyst; C_{CO2} indicates carbon dioxide emission; C_{SO2} represents sulfur dioxide emission.

Further, the objective function can be expressed as:

P=F(x₁,x₂, . . . ,xᵢ)
wherein P is objective function; x₁, x₂, . . . , xᵢ(i=1,2,3, . . . , n) are process decision variables, which includes but not limited to feed temperature, feed pressure, first reaction zone outlet temperature, reactor pressure, feed mass flow, regenerated catalyst activity index, oxygen index; constraint range of process decision variables is x_{i min}<xᵢ≤x_{i max} (i=1, 2, 3, . . . , n), wherein x_{i min} is lower limit value of process decision variables and x_{i max} is upper limit value of process decision variables.

As shown in FIG. 1, after determining the objective function P according to a plurality of optimization objectives and a plurality of process decision variables, the multi-objective optimization device can adjusting value of each of the process decision variables within the constraint range by SPEA2 algorithm (Strength Pareto Evolutionary Algorithm), which improves filial generation evolution process through a path-based reproduction operator, thereby determining an operation data of the objective function on each of the process decision variables.

Pareto analysis method is a commonly used primary and secondary factor analysis method in project management, and its core idea is to distinguish the primary and secondary factors among the many factors that determine a thing, and identify a few key factors that play a decisive role in things and many secondary factors that have less impact on things.

Without losing generality, the multi-objective optimization problem can be described as follows:

Minimize^{F(x)=(f}ᵢ(x), . . . , f_{M}(x))
Subject to ^{x∈Ω}
wherein Ω⊆ [symbol] ^{D} is a D dimension decision space; objectives in the formula fᵢ(x) are usually in conflict with each other; improvement of one goal usually leads to the deterioration of another goal; F: Ω→ [symbol] ^{M} is a mapping function multi-objective optimization, that maps decision variables to the M-dimensional objective space, and attempts to obtain a set of objective values in the objective space, called Pareto Front (PF); correspondingly, obtain a set of solutions in decision space, called Pareto Set (PS).

The multi-objective optimization algorithm SPEA2PE based on Pareto dominated integrated path reproduction operator is an elite multi-objective evolutionary algorithm to enhance Pareto, which adopts the algorithm framework of the classic multi-objective optimization algorithm SPEA2, which can find a plurality of Pareto optimal solutions in a single run, and takes the solution in the external set as the approximation of the Pareto optimal solution of the problem after the algorithm ends.

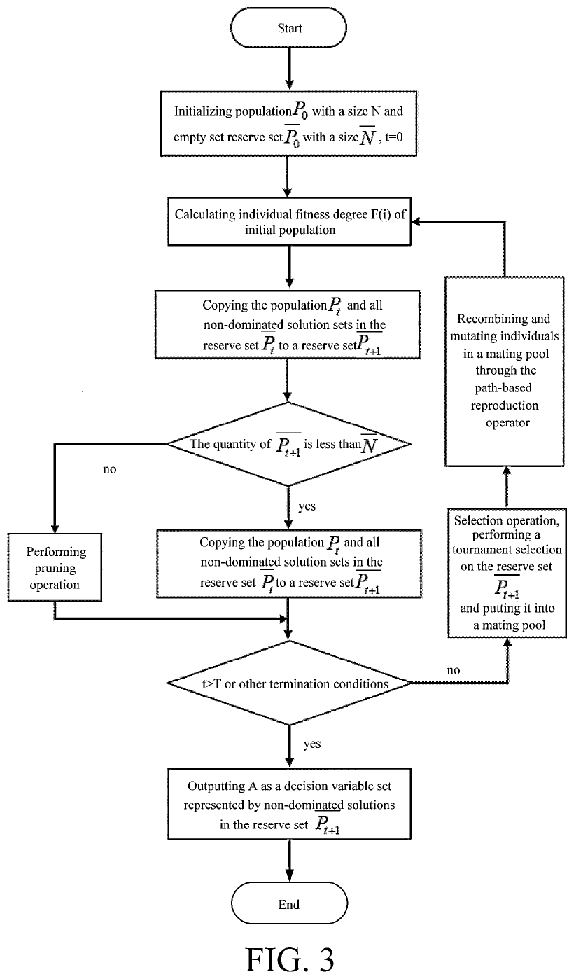

Please referring to FIG. 3, FIG. 3 shows a flow schematic diagram of adjusting process decision variables provided according to some embodiments of the present invention.

As shown in FIG. 3, in the process of adjusting a value of the process decision variables by improved SPEA2 algorithm, the multi-objective optimization device can perform the following steps in turn:
S1: initializing an iteration count variable t, a population Pₜ and a reserve set P̅ₜ̅, wherein initialized population P₀ is composed of a set of the plurality of process decision variables when t=0, and initialized reserve set P̅₀̅ is an empty set;
S2: calculating a fitness degree F(i) of each individual i in the population Pₜ, wherein each of the individuals i corresponds to one of the process decision variables;
S3: copying the population Pₜ and all non-dominated solution sets in the reserve set P̅ₜ̅ to a reserve set P̅ₜ̅₊̅₁̅, and performing an environmental selection on the reserve set P̅ₜ̅₊̅₁̅;
S4: if iteration count t does not reach a preset upper limit of iteration count T, performing a tournament selection on the reserve set P̅ₜ̅₊̅₁̅ that have undergone the environmental selection, and putting a data set that have undergone the tournament selection into a mating pool;
S5: calculating the data set in the mating pool through the path-based reproduction operator and storing calculation results in the reserve set P̅ₜ̅₊̅₁̅, increasing the iteration count, and returning to the step S2; and
S6: if the iteration count t reaches the upper limit of iteration count T, outputting a process decision variable set A represented by non-dominated solutions in the reserve set P̅ₜ̅₊̅₁̅.

Specifically, in the process of calculating a fitness degree F(i) of each individual i in the population Pₜ (i.e. step S2), the multi-objective optimization device can first determine an individual quantity S(i) dominated by the individual i, and then determine the original fitness value R(i) of the individual i according to the individual quantity S(i) dominated by individual i:

$$S ( i ) = \vert \{ j \vert j ∈ {P}_{t} + \overline{{P}_{t}} ⋂ j < i \}$$

$$R ( i ) = {\sum }_{j ∈ {P}_{t} + \overline{{P}_{t}} , i < j} S ( j )$$

wherein original fitness value R(i) represents individual i, and the sum of all individuals dominated by each individual j that dominates individual i.

Then, the multi-objective optimization device can calculate the distance from each of the individuals i to each individual in the population Pₜ and the reserve set P̅ₜ̅, and sorting the distances in an ascending order. Then, the multi-objective optimization device can select the kth individual as σᵢ^{k}, and calculate the corresponding distance value D(i):

$$D ( i ) = \frac{1}{{σ}_{i}^{k} + 2}$$

wherein k=\sqrt{N+N̅}, N is a size of the population Pₜ, and N̅ is a size of the reserve set P̅ₜ̅, and denominator is added with 2 to ensure the distance value D(i)∈(0,1).

Then, the multi-objective optimization device can determine the fitness degree F(i) of individual i according to the original fitness value R(i) and distance value D(i):

$$F ( i ) = R ( i ) + D ( i ) .$$

In the process of performing an environmental selection on the reserve set P̅ₜ̅₊̅₁̅ (step S3), the multi-objective optimization device can first compare the individual quantity in the reserve set P̅ₜ̅₊̅₁̅ with the size N̅ of the reserve set. If |p̅ₜ̅₊̅₁̅|<|N̅| the multi-objective optimization device can first N̅−|p̅ₜ̅₊̅₁̅| individuals from all individuals i in the population Pₜ and the reserve set P̅ₜ̅ according to order of the fitness degree F(i) to form a dominated solution set, and adding it to the reserve set P̅ₜ̅₊̅₁̅. On the contrary, if |p̅ₜ̅₊̅₁̅|>|N̅|, the multi-objective optimization device can performing a pruning operation, and eliminating the individual i with a minimum distance from its adjacent individual in each iteration, wherein the individual i meets:

$${D}_{i} \leq {D}_{j} ⇔ ∀ 0 < k < \vert \overline{{P}_{t + 1}} \vert : {σ}_{i}^{k} = {σ}_{j}^{k} ⋃$$

$$∃ 0 < k < \vert \overline{{P}_{t + 1}} \vert : [ ( ∀ 0 < l < k : {σ}_{i}^{l} = {σ}_{j}^{l} ) ⋂ {σ}_{i}^{k} < {σ}_{j}^{k} ]$$

wherein σₗ^{k} represents the distance between individual i and the kth neighbor. The above formula indicates that the distance between all individuals and neighbors is sorted, and select to delete the individual i with the minimum adjacent distance (k and i are not necessarily the neighbors with the minimum distance to each other), so as to reduce population crowding and ensure population diversity. Further, if there are a plurality of individuals with the same minimum distance, the multi-objective optimization device can determine that these individuals with the same distance have a greater degree of correlation with the objective function P, and prefer to retain these individuals and consider to delete the individual i′ with the second minimum adjacent distance, thereby retaining the individual i with the minimum distance. Similarly, if there are a plurality of individuals with the same second minimum distance, the multi-objective optimization device can further consider the individual i″ with the third minimum adjacent distance, and retaining the individual i with the minimum distance value and the individual i″ with the second minimum distance, and so on, until the unique individual i with the minimum distance is deleted.

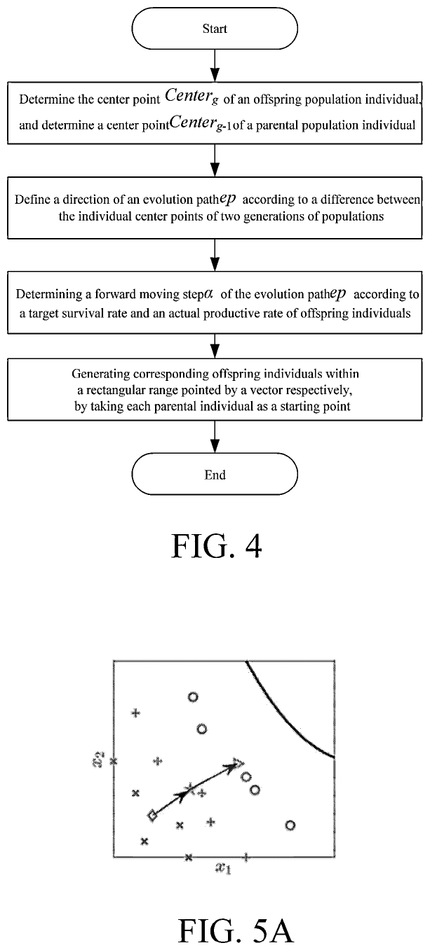

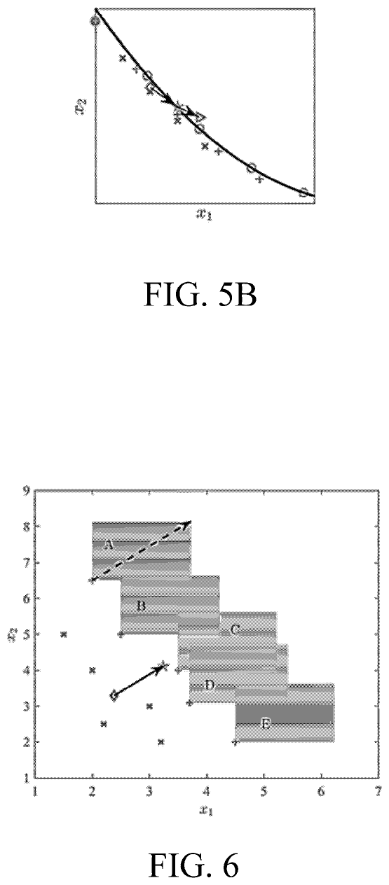

Please refer to FIG. 4, FIG. 5A, FIG. 5B and FIG. 6. FIG. 4 shows a flow schematic diagram for calculating a data set in a mating pool provided according to some embodiments of the present invention. FIG. 5A shows a schematic diagram of an evolution path at the early stage of the evolution provided according to some embodiments of the invention. FIG. 5B shows a schematic diagram of an evolution path at the later stage of the evolution provided according to some embodiments of the invention. FIG. 6 shows a schematic diagram of generating offspring individuals provided according to some embodiments of the present invention.

As shown in FIG. 4, in the process of calculating the data set in the mating pool through the path-based reproduction operator (i.e. step S5), the multi-objective optimization device can first input the each of the offspring decision variables x_{g} and the parental decision variables x_{g-1} into the path-based reproduction operator (Path Evolution, PE), and determine the center point Center_{g} of an offspring population individual in the reserve set P̅ₜ̅₊̅₁̅ according to the formula Center_{g}=mean(x^{l}, . . . , xⁱ, . . . , x^{N}), and determine a center point Center_{g-1} of a parental population individual in the population Pₜ and the reserve set Pₜ, wherein xⁱ=(x₁^{l}, . . . , xⱼⁱ, . . . , x_{D}ⁱ), Center_{g} is center point of the gth generation population individuals, N is individuals quantities in the population, (Center_{g}(j)=Σᵢ₌₁^{N}xⱼⁱ/N) and D is quantity of decision variables. Herein, each of the individuals is involved in the calculation of the population center.

Then, the multi-objective optimization device can define a direction of an evolution path eP according to a difference between the individual center points of two generations of populations, namely ep=Center_{g}−Center_{g-1}.

In addition, the multi-objective optimization device can also determine a forward moving step α of the evolution path ep adaptively according to a target survival rate p_{succ}^{target} and an actual productive rate p_{succ} of offspring individuals, that is

$$α = \{ \begin{matrix}min ( α * ω , {α}_{ub} ) , {p}_{succ} > {p}_{succ}^{target} \\ max ( α / ω , {α}_{ib} ) , otherwise\end{matrix}$$

wherein p_{succ}^{target}∈(0,1) is a user-defined parameter, representing the target survival rate of the offspring individuals, that is, the target percentage of the offspring individuals evolving to the next generation; p_{succ} is productive rate of the actual offspring individuals, its value is equal to the quantity of offspring individuals evolving to the next generation divided by the quantity N of populations in each generation; parameter ω∈(1, ∞) determines the speed α increases or decreases.

As shown in FIG. 5A, in the early stage of the evolution process, p_{succ}>p_{succ}^{target}, most individuals in the decision space are far away from the optimal PS, and non-dominated individuals are relatively easy to generate. At this time, the ep length α, and the included angle between ep and the optimal PS are both relatively large, and α will increase at a rate of ω times to form a clear evolutionary path, so that the population quickly moves toward the optimal PS. Further, this will result in a larger α, thereby forming a more potential and longer evolutionary path. The above process is a positive feedback process. By increasing α, the improved algorithm requires less computing resources and has significantly faster convergence speed. In order to avoid moving too far in the direction of ep in any generation, so as to guide the offspring individuals incorrectly, the multi-objective optimization device can set an upper limit value α_{ub} for α.

As shown in FIG. 5B, in the later stage of the evolution process, p_{succ}≤p_{succ}^{target}, the algorithm has basically completed convergence, and the population is near the optimal PS. At this time, the ep length α and the included angle between ep and the optimal PS are both relatively small, and α will decrease at a rate of ω times, so that each individual can conduct local search in the PS neighborhood around itself, to increase the diversity of the population, and obtain a group of solutions evenly distributed along the optimal PS. In some embodiments, the PE operator can slightly increase the diversity of genes in the population by means of polynomial mutation. This process can generally be realized through a relatively small α, that is, each individual has a small disturbance in its original position to generate potential offspring individuals, or most individuals move from one end of PS to the other to achieve a more uniform distribution. Furthermore, in order to ensure that each gene has an appreciable disturbance, the multi-objective optimization device can set a lower limit α_{lb} value for α.

Further, if all the element values in ep are very small, the resulting offspring individuals (Xₜₑₘₚ₁(i,:)) will be very close to its parental individuals (X_{g}(i,:)), which will be very detrimental to the evolution process. Therefore, when the maximum element in nep is less than the preset minimum normalized evolution path length min C, the multi-objective optimization device can randomly initialize an element value in Center_{g} in order to ensure that the difference between (Center_{g-1} and Center_{g} is sufficiently obvious, that is, ensure that the element value in eP is not too small, so as to prevent the population from being limited to local optimization.

As shown in FIG. 6, after determining the direction and step size α of the evolution path ep, the multi-objective optimization device can generating corresponding offspring individuals within a rectangular range pointed by a vector α*ep, by taking each parental individual as a starting point.

By using all the individuals in the previous and subsequent generations to calculate the evolution path ep, the invention can save the trouble of selecting specific individuals on the one hand, so that the calculation of ep is simpler. On the other hand, compared with the PSO operator, ep is more robust and reliable to compute using all individuals, so that most of the offspring individuals can benefit from eP. In addition, preliminary experiments show that most individuals show a relatively consistent evolutionary direction in the early and late stages of evolution, so the entire population can share this evolutionary direction, which can effectively improve the convergence speed of the operator and ensure the diversity of the population.

Further, in order to share some excellent individual genes in the whole population, the multi-objective optimization device can also perform Gene-Sharing Operation between at least one excellent parental individual and each offspring individual after the generation of offspring individuals. Specifically, the multi-objective optimization device can first obtain the Pareto front layers or fitness degree F(i) of each parental individual. If the quantity of Pareto front layers equals to 1, the multi-objective optimization device can determine that there is a solution that is not dominated by any solution. Thus, the multi-objective optimization device can identify the parental individuals with Pareto front layer equals to 1 or better fitness degree F(i) as the carriers of excellent genes, so as to screen at least one excellent parental individual. After that, the multi-objective optimization device can refer to the simulated binary crossover (SBX) operator to perform crossover operation on each variable with a probability of 0.5, so as to share the excellent genes in the parental individual that have a greater correlation with the objective function in the offspring. The present invention can further improve the convergence of the algorithm and the diversity of the population by only performing the gene sharing operation between the offspring individual and the excellent parental individual.

Further, in some embodiments, after obtaining the operating data of the objective function P using the improved SPEA2 algorithm to adjust the value of the process decision variable within the constraint range, the multi-objective optimization device can also preferably judge whether the current operating value ₓᵢ of each process decision variable is within the constraint range x_{i min}˜x_{i max} of the process decision variable. If the current operating value xᵢ is within the constraint range x_{i min}˜x_{i max} of the process decision variable, the multi-objective optimization device can take the current operating value ₓᵢ as the initial value of the process decision variable. Conversely, if the current operating valueₓᵢ exceeds the constraint range of the process decision variable x_{i min}˜x_{i max}, the multi-objective optimization device can execute the repair function in the algorithm (for example, re execute the S1 step of the SPEA2 algorithm to get the initial population P₀, and add the generated initial population P₀ to the existing population). After that, the multi-objective optimization device can regenerate the operation data xᵢ of each decision variable within the constraint range x_{i min}˜x_{i max} of the process decision variable to serve as the initial value of each process decision variable.

As shown in FIG. 1, after determining the operation data of each process decision variable, the multi-objective optimization device can determine the optimization target value of each optimization target according to the operation data of each process decision variable. Then, the multi-objective optimization device can determine the corresponding operation data as guide values of the plurality of process decision variables, corresponding to the plurality of optimization objectives, according to an optimal optimization objective value solution set.

Specifically, the multi-objective optimization device can first input the operation data into the mechanism model of the catalytic cracking process to obtain the yield data of various products and gases. Then, the multi-objective optimization device can input the yield data into each objective function to obtain the optimization target value of each optimization target.

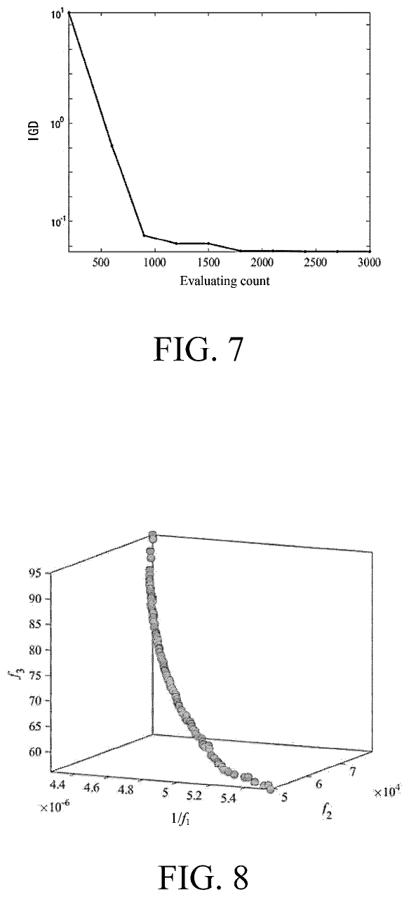

For example, the multi-objective optimization device can send the corresponding operating data into the catalytic cracking mechanism model through the interface of Matlab and the process simulation software Aspen Hysys to calculate the f₃ benefit values of each optimization goal f₁, f₂, respectively. Then, the multi-objective optimization device can evaluate each optimization target value according to Pareto optimal solution set and IGD indicators as shown in FIG. 7 and FIG. 8 to determine the optimal optimization target value solution set.

By using the improved SPEA2 algorithm to adjust the value of each process decision variable within the constraint range, the present invention can realize the data linkage between the PE operator and the catalytic cracking mechanism model through the programming means of Matlab software and the catalytic cracking mechanism model interface program. Then, the multi-objective optimization device can run the control program, automatically calculate the value of the objective function P under different decision variables by calling data, programs and algorithms, and continuously optimize the value of each process decision variable to make the objective function value better, so as to obtain the operating data of the objective function.

Furthermore, the improved SPEA2 algorithm will automatically change different step size change strategies according to the specific situation as described above, so that performing incomplete polling calculation according to different step size change strategies within the constraint range, and obtaining better operation data of the objective function continuously until the objective function value reaches the optimal value.

Taking the catalytic cracking device shown in FIG. 2 as an example, the process decision variables include but not limited to: feed temperature x₁, feed pressure x₂, first reaction zone outlet temperature x₃, reactor pressure X₄, hydrogenation wax oil feed mass flow x₅, tank farm wax oil feed mass flow x₆, tank farm wax oil feed mass flow x₇, tank farm residual oil feed mass flow, regenerated catalyst activity index x₈ and oxygen index x₉.

Correspondingly, the constraint range of each process decision variable includes but not limited to:

210≤x₁≤220

850≤x₂≤900

515≤x₃≤530

210≤x₄≤230

55≤x₅≤61

2≤x₆≤4

225≤x₇≤240

105≤x₈≤120

0≤x₉≤45

The multi-objective optimization device can send the corresponding operation data into the catalytic cracking mechanism model through the interface of Matlab and the process simulation software Aspen Hysys to calculate the benefit values of each optimization goal f₁, f₂, f₃ respectively. Please refer to Table 1, Table 1 shows the comparison data of optimization results provided according to some embodiments of the present invention.

TABLE 1

| | Before | After |
|---|---|---|
| Project | optimization | optimization |
| Feed temperature (° C.) | 216.8 | 210.0 |
| Feed pressure (kPa) | 880.3 | 850.0 |
| Outlet temperature of the first reaction | 527.8 | 515.0 |
| zone (° C.) | | |
| Reactor pressure (kPa) | 222.9 | 210.0 |
| Hydrogenated wax oil feed mass flow | 230.0 | 225.0 |
| (tone/h) | | |
| Tank farm wax oil feed mass flow | 110.0 | 119.1 |
| (tone/h) | | |
| Tank farm residual oil feed mass flow | 40.0 | 41.2 |
| (tone/h) | | |
| Regenerated catalyst activity index (%) | 58.0 | 57.5 |
| Oxygen (%) | 2.4 | 2.0 |
| Economic benefits (yuan/h) | 215100.0 | 226000 |
| CO2 emissions (tone/h) | 95.2 | 71.7 |
| Sulfur dioxide emission (tone/h) | 0.125 | 0.0818 |

As shown in FIG. 1, if substituting the operation data before optimization of each process decision variable into the objective function P for calculation, it can be calculated that the economic benefits are 215100.0 yuan/b, the carbon dioxide emissions are 95.2 th, and the sulfur dioxide emissions are 0.125 t/h. Conversely, if substituting the operation data after optimization of each process decision variable into the objective function P for calculation, it can be calculated that the economic benefits are 226000 yuan/h, the carbon dioxide emissions are 71.7 t/h, and the sulfur dioxide emissions are 0.0818 t/h.

It can be understood that the above results are arbitrarily taken from the Pareto optimal solution set, and do not represent the optimal effect of the present invention. However, we can also see a comprehensive and significant optimization effect by comparing the data before and after optimization. Therefore, the optimized operation data can provide guidance for the optimal operation of the catalytic cracking device, and reduce the emission of carbon dioxide and sulfur dioxide while improving economic benefit.

Although the above methods are illustrated and described as a series of actions in order to simplify the explanation, it should be understood and appreciated that these methods are not limited by the order of actions, because according to one or more embodiments, some actions can occur in different order and/or concurrently with other actions from the illustrations and descriptions herein or not illustrated and described herein, but can be understood by those skilled in the art.

The previous description of the disclosure is provided to enable any person skilled in the art to make or use the disclosure. Various modifications to the disclosure will be apparent to those skilled in the art, and the universal principles defined herein can be applied to other variants without departing from the spirit or scope of the disclosure. Therefore, this disclosure is not intended to be limited to the examples and designs described herein, but should be granted the widest scope consistent with the principles and novel features disclosed herein.

1. A multi-objective optimization method for catalytic cracking process, comprising following steps:
determining a plurality of optimization objectives, a plurality of process decision variables corresponding to the plurality of optimization objectives, and a constraint range of each of the process decision variables;
determining an objective function according to the plurality of optimization objectives and the plurality of process decision variables;
adjusting a value of each of the process decision variables within the constraint range by SPEA2 algorithm, which improves filial generation evolution process through a path-based reproduction operator, thereby determining an operation data of the objective function on each of the process decision variables;
determining an optimization objective value of each of the optimization objectives according to the operation data of each of the process decision variables; and
determining the operation data as guide values of the plurality of process decision variables, corresponding to the plurality of optimization objectives, according to an optimal optimization objective value solution set.

2. The multi-objective optimization method according to claim 1, wherein steps of adjusting a value of each of the process decision variables within the constraint range by SPEA2 algorithm, which improves filial generation evolution process through a path-based reproduction operator, thereby determining an operation data of the objective function on each of the process decision variables comprise:
S1: initializing an iteration count variable t, a population Pₜ and a reserve set P̅ₜ̅, wherein initialized population P₀ is composed of a set of the plurality of process decision variables when t=0, and initialized reserve set P̅₀̅ is an empty set;
S2: calculating a fitness degree F(i) of each individual i in the population Pₜ, wherein each of the individuals i corresponds to one of the process decision variables;
S3: copying the population Pₜ and all non-dominated solution sets in the reserve set P̅ₜ̅ to a reserve set P̅ₜ̅₊̅₁̅, and performing an environmental selection on the reserve set P̅ₜ̅₊̅₁̅;
S4: if iteration count t does not reach a preset upper limit of iteration count T, performing a tournament selection on the reserve set P̅ₜ̅₊̅₁̅ that have undergone the environmental selection, and putting a data set that have undergone the tournament selection into a mating pool;
S5: calculating the data set in the mating pool through the path-based reproduction operator and storing calculation results in the reserve set P̅ₜ̅₊̅₁̅, increasing the iteration count, and returning to the step S2; and
S6: if the iteration count t reaches the upper limit of iteration count T, outputting a process decision variable set A represented by non-dominated solutions in the reserve set P̅ₜ̅₊̅₁̅.

3. The multi-objective optimization method according to claim 2, wherein steps of calculating a fitness degree F(i) of each individual i in the population Pₜ comprise:
determining an original fitness value R(i) of the individual i according to an individual quantity S(i) dominated by the individual i, wherein the original fitness value R(i) represents a sum of quantity of all individuals dominated by the individual i and each individual j that dominates the individual i;
calculating a distance from each of the individuals i to each individual in the population Pₜ and the reserve set P̅ₜ̅, and sorting the distances in an ascending order;
selecting a kth individual as σᵢ^{k}, and calculating a corresponding distance value D(i), wherein k=\sqrt{N+N̅}, N is a size of the population Pₜ, and N̅ is a size of the reserve set P̅ₜ̅; and
determining the fitness degree F(i) of the individual i, according to the original fitness value R(i) and the distance value D(i).

4. The multi-objective optimization method according to claim 3, wherein steps of performing an environmental selection on the reserve set P̅ₜ̅₊̅₁̅ comprise:
comparing an individual quantity in the reserve set P̅ₜ̅₊̅₁̅ with the size N̅ of the reserve set;
if |p̅ₜ̅₊̅₁̅|<|N̅|, selecting first N̅−|p̅ₜ̅₊̅₁̅| individuals from all individuals i in the population Pₜ and the reserve set P̅ₜ̅ according to order of the fitness degree F(i) to form a dominated solution set, and adding it to the reserve set P̅ₜ̅₊̅₁̅; and
if |P̅ₜ̅₊̅₁̅|>|N̅|, performing a pruning operation, thereby eliminating the individual i with a minimum distance from its adjacent individual in each iteration.

5. The multi-objective optimization method according to claim 4, wherein step of eliminating the individual i with a minimum distance from its adjacent individual in each iteration comprises:
eliminating one individual i with a minimum distance from its adjacent individual in each of the iterations.

6. The multi-objective optimization method according to claim 3, wherein steps of calculating the data set in the mating pool through the path-based reproduction operator comprise:
determining a center point Center_{g} of an offspring population individual in the reserve set P̅ₜ̅₊̅₁̅, and determining a center point Center_{g-1} of a parental population individual in the population Pₜ and the reserve set P̅ₜ̅;
defining a direction of an evolution path ep according to a difference between the individual center points of two generations of populations;
determining a forward moving step α of the evolution path ep according to a target survival rate p_{succ}^{target} and an actual productive rate p_{succ} of offspring individuals; and
generating corresponding offspring individuals within a rectangular range pointed by a vector α*ep by taking each parental individual as a starting point.

7. The multi-objective optimization method according to claim 6, wherein steps of calculating the data set in the mating pool through the path-based reproduction operator further comprise:
after generating the offspring individuals, performing a gene sharing operation between at least one excellent parental individual and each of the offspring individuals.

8. The multi-objective optimization method according to claim 7, wherein before performing the gene sharing operation, the multi-objective optimization method further comprises following steps:
obtaining a number of Pareto front layers or the fitness degree F(i) of each of the parental individuals; and
screening at least one excellent parental individual according to the number of the Pareto front layers or the fitness degree F(i).

9. The multi-objective optimization method according to claim 2, wherein before determining the operation data as guide values of the plurality of process decision variables, corresponding to the plurality of optimization objectives, according to an optimal optimization objective value solution set, the multi-objective optimization method also comprises a following step:
evaluating each of the optimization objective values according to a Pareto optimal solution set and an IGD index, thereby determining the optimal optimization objective value solution set.

10. The multi-objective optimization method according to claim 1, wherein the plurality of optimization objectives at least comprise minimizing carbon dioxide emission.

11. The multi-objective optimization method according to claim 10, wherein the plurality of optimization objectives also comprise at least one of maximizing economic benefit, minimizing sulfur dioxide emission, minimizing total exhaust gas emission, minimizing total waste liquid emission, maximizing main product output, maximizing main product yield, and minimizing input cost.

12. The multi-objective optimization method according to claim 10, wherein the plurality of process decision variables at least comprise at least one of material flow, material state, material property, main fractionate tower state, main fractionate tower operation, absorption tower state, absorption tower operation, re-absorption tower state, re-absorption tower operation, desorption tower state, desorption tower operation, stabilization tower state, and stabilization tower operation.

13. The multi-objective optimization method according to claim 10, wherein the plurality of optimization objectives comprise maximizing economic benefit, minimizing carbon dioxide emission and minimizing sulfur dioxide emission, and the objective function is as follows:
$$min imizeF ( x ) = ( 1 / {f}_{1} , {f}_{2} , {f}_{3} ) ,$$
$${f}_{1} = max M = {\sum }_{i} {P}_{i} \times {Y}_{i} - {\sum }_{j} {p}_{j} \times {y}_{j} - {P}_{f} \times F - {p}_{c} \times {f}_{c} ,$$
$${f}_{2} = min {C}_{CO 2} ,$$
$${f}_{3} = min {C}_{SO 2} ,$$
wherein M indicates economic benefit of the catalytic cracking process; Pᵢ indicates price of product i; Yᵢ indicates flow of product i; i indicates products, comprising at least one of sour gas, dry gas, ethylene, liquefied gas, propylene, gasoline, diesel oil, circulating oil, slurry and coke; pⱼ indicates price of raw material j; yⱼ indicates flow of raw material j; j indicates raw materials, including residual oil in tank farm, wax oil in tank farm and refined wax oil; P_{f} indicates fixed cost per unit processing quantity, F indicates processing load; p_{c} indicates price of fresh catalyst and f_{c} indicates supplement amount of fresh catalyst; C_{CO2} indicates carbon dioxide emission; C_{SO2} represents sulfur dioxide emission.

14. A multi-objective optimization device for catalytic cracking process, comprising:
a memory; and
a processor, connected to the memory and configured to implement the multi-objective optimization method for catalytic cracking process according to claim 1.

15. A computer-readable storage medium, in which computer instructions are stored, wherein when the computer instructions are executed by a processor, the multi-objective optimization method for catalytic cracking process according to claim 1 is implemented.
